(19) United States
(12) Patent Application Publication
(10) Pub. No.: US 2006/0065715 A1
(43) Pub. Date: Mar. 30, 2006

(54) Charge settlement device and charge settlement system

(75) Inventors: Masanori Kojima, Nagano-ken (JP); Yasushi Nakaoka, Nagano-ken (JP); Masaaki Hanaoka, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/212,597

(22) Filed: Aug. 29, 2005

(30) Foreign Application Priority Data
Aug. 30, 2004 (JP) 2004-250645

(51) Int. Cl. G06K 5/00

(52) U.S. Cl. 235/380

(57) ABSTRACT

The charge settlement device of the invention has an information reading unit. When a certain fee is charged to a user and the user places a contactless storage medium, which stores electronic money information and user identification information for identification of the user, close to the information reading unit, the charge settlement device subtracts an amount corresponding to the certain fee from available electronic money represented by the electronic money information for payment of the certain fee. When the user places the contactless storage medium close to the information reading unit, the user is identified based on the user identification information obtained from the contactless storage medium. In response to detection of the certain fee charged to the identified user, indication of the user identification information and a payment request, which asks the user to place the contactless storage medium close to the information reading unit for payment, is kept until the user actually places the contactless storage medium close to the information reading unit. The technique of the invention effectively restrains the user from going away without the required payment.

### BACKGROUND OF THE INVENTION

1. Field of the Invention

The present invention relates to a charge settlement system that utilizes a contactless storage medium for payment of a certain fee.

2. Description of the Related Art

Charge settlement devices have been spread recently to allow each user to utilize a contactless card storing electronic money information, for example, FeliCa (trademark by Sony Corporation) for payment of a certain fee according to accounting information. The charge settlement device is connected to a card reader that reads the electronic money information from the contactless card. When the user places the contactless card close to the card reader to pay for the certain fee according to the accounting information, the charge settlement device controls the card reader to subtract an amount of money corresponding to the certain fee from available electronic money represented by the electronic money information stored in the contactless card for payment of the certain fee.

A printing charge settlement device is connected to a printing device, for example, a copying machine or a printer, and is used for payment of a printing fee according to accounting information of a print. The printing charge settlement device specifies a printing fee based on printing result information, which is obtained only after completion of printing, for example, the total number of print pages and requests the user to pay for the specified printing fee. When the user pays for the printing charge with the contactless card storing the electronic money information, the printing charge settlement device asks the user to place the contactless card close to the card reader and pays for the printing charge, which is charged to the user for a print and is specified after completion of printing.

The technique disclosed in Japanese Patent Laid-Open Gazette No. 2001-34816 is adopted in a charge settlement system that uses a prepaid card storing electronic money information and subtracts an amount of money corresponding to a certain fee from available electronic money represented by the electronic money information stored in the prepaid card for payment of the certain fee.

There may be, however, some vicious users who do not duly pay for printing fees, even after receiving desired prints and payment requests for the printing fees from the printing charge settlement device. Such a wicked user does not place the contactless card close to the card reader but immediately goes away without payment for the printing fee.

This problem is not restricted to the contactless card storing the electronic money information, but is commonly found in any contactless storage media storing electronic money information. The contactless storage media include, for example, cell phones and PDAs having the similar functions to those of the contactless card. This problem is also not restricted to the printing charge settlement device that asks the user to pay for a printing charge after completion of printing, but is commonly found in any charge settlement devices that ask the user to pay for certain fees.

### SUMMARY OF THE INVENTION

The present invention is thus to eliminate the drawbacks of the prior art technique and to provide a technique adoptable in a charge settlement device that utilizes a contactless storage medium storing electronic money information for payment to restrain a user from going away without required payment for a certain fee charged to the user.

In order to attain at least part of the above and the other related objects, the present invention is directed to a charge settlement device having an information reading unit. When a certain fee is charged to a user and the user places a contactless storage medium, which stores electronic money information and user identification information for identification of the user, close to the information reading unit, the charge settlement device subtracts an amount corresponding to the certain fee from available electronic money represented by the electronic money information for payment of the certain fee.

The charge settlement device includes: a notification unit; and a system control module that controls the information reading unit and the notification unit.

When the user places the contactless storage medium close to the information reading unit, the system control module controls the information reading unit to obtain at least the user identification information from the contactless storage medium. The system control module identifies the user based on the obtained user identification information. In response to detection of the certain fee charged to the identified user, the system control module controls the notification unit to keep indication of the user identification information and a payment request, which asks the user to place the contactless storage medium close to the information reading unit for payment, until the user actually places the contactless storage medium close to the information reading unit.

The charge settlement device of the invention keeps the indication of the payment request and the user identification information until the user's payment. In the case where the user has gone away without required payment for the certain fee, such indication notifies people near to the charge settlement device of the fact that the user has not paid for the certain fee charged to the user. This is naturally awkward for the user and thus effectively restrains the user from going away without the required payment.

In one preferable embodiment of the charge settlement device of the invention, in response to detection of the certain fee charged to the identified user, the system control module controls the notification unit to keep indication of an amount of money to be paid corresponding to the certain fee, together with the user identification information and the payment request to ask the user to place the contactless storage medium close to the information reading unit for payment.

This arrangement promptly informs the user of the amount of money to be paid corresponding to the certain fee.

In another preferable embodiment of the charge settlement device of the invention, the system control module controls the notification unit to terminate the indication when the user has not placed the contactless storage medium close to the information reading unit for payment within a predetermined time period.

The charge settlement device is unusable during the indication of the payment request and the user identification information by the notification unit. This arrangement allows another use to use the charge settlement device after elapse of the predetermined time period.

Another application of the present invention to attain at least part of the above and the other related objects is a charge settlement system that includes the charge settlement device of the above arrangement connected to a management server via a network.

The system control module of the charge settlement device stores a log that specifies whether the user has duly paid for the certain fee in response to the payment request and sends the stored log to the management server at a preset timing.

The arrangement of the charge settlement system enables a manger of the management server to request the user who has an unpaid charge to pay for the certain fee charged to the user.

In order to attain at least part of the above and the other related objects, the present invention is also directed to a printing charge settlement device having a printing unit and an information reading unit. When a printing fee is charged to a user for a print by the printing unit and the user places a contactless storage medium, which stores electronic money information and user identification information for identification of the user, close to the information reading unit, the printing charge settlement device subtracts an amount corresponding to the printing fee from available electronic money represented by the electronic money information for payment of the printing fee.

The printing charge settlement device includes: a notification unit; and a system control module that controls the information reading unit and the notification unit.

When the user places the contactless storage medium close to the information reading unit, the system control module controls the information reading unit to obtain at least the user identification information from the contactless storage medium. The system control module identifies the user based on the obtained user identification information. In response to detection of the printing fee charged to the identified user for the print by the printing unit, the system control module controls the notification unit to keep indication of the user identification information and a payment request, which asks the user to place the contactless storage medium close to the information reading unit for payment, until the user actually places the contactless storage medium close to the information reading unit.

The printing charge settlement device of the invention keeps the indication of the payment request and the user identification information until the user's payment. In the case where the user has gone away without required payment for the printing fee, such indication notifies people near to the printing charge settlement device of the fact that the user has not paid for the printing fee charged to the user for the print. This is naturally awkward for the user and thus effectively restrains the user from going away without the required payment.

In one preferable embodiment of the printing charge settlement device of the invention, in response to detection of the printing fee charged to the identified user for the print by the printing unit, the system control module controls the notification unit to keep indication of an amount of money to be paid corresponding to the printing fee, together with the user identification information and the payment request to ask the user to place the contactless storage medium close to the information reading unit for payment.

This arrangement promptly informs the user of the amount of money to be paid corresponding to the printing fee for the print.

In another preferable embodiment of the printing charge settlement device of the invention, the system control module controls the notification unit to terminate the indication when the user has not placed the contactless storage medium close to the information reading unit for payment within a predetermined time period.

The printing charge settlement device is unusable during the indication of the payment request and the user identification information by the notification unit. This arrangement allows another use to use the printing charge settlement device after elapse of the predetermined time period.

In still another preferable embodiment of the printing charge settlement device of the invention, when the user places the contactless storage medium close to the information reading unit, the system control module controls the information reading unit to obtain the electronic money information and the user identification information from the contactless storage medium. The system control module identifies the user based on the obtained user identification information. The system control module allows a print job specified by the identified user to be printed by the printing unit to an extent where a printing charge for the print job does not exceed the available electronic money represented by the obtained electronic money information, and charging the user with the printing fee for the print.

This arrangement prevents the printing charge for the print job from exceeding the available electronic money represented by the electronic money information stored in the user's contactless storage medium and thus effectively reduces the potential for insufficient payment.

Another application of the present invention to attain at least part of the above and the other related objects is a printing charge settlement system that includes the printing charge settlement device of the above arrangement connected to a management server via a network.

The system control module of the printing charge settlement device stores a log that specifies whether the user has duly paid for the printing fee in response to the payment request and sends the stored log to the management server at a preset timing.

The arrangement of the printing charge settlement system enables a manger of the management server to request the user who has an unpaid charge to pay for the printing fee charged to the user for the print.

The technique of the invention is not restricted to the charge settlement device, the charge settlement system, the printing charge settlement device, or the printing charge settlement system described above, but may be applicable to a corresponding charge settlement method and a corresponding printing charge settlement method. Other possible applications of the invention include computer programs to establish the charge settlement device, the printing charge settlement device, the corresponding charge settlement systems, and the corresponding charge settlement methods, recording media in which such computer programs are recorded, and data signals that include such computer programs and are embodied in carrier waves.

In the applications of the invention as the computer programs and the recording media in which the computer programs are recorded, the invention may be given as a whole program to control the operations of the charge settlement device, the charge settlement system, the printing charge settlement device, or the printing charge settlement system or as a partial program to exert only the characteristic functions of the invention.

### BRIEF DESCRIPTION OF THE DRAWINGS

FIG. 1 schematically illustrates the configuration of a campus print system CPS in one embodiment of the invention;

FIG. 2 shows the structure of a printing system PS1 and a management server MSV included in the system of the embodiment;

FIG. 3 shows the functions of a contactless electronic money card EC and a card reader CR1 in the embodiment;

FIG. 4 is a flowchart showing a printing and payment routine executed in the embodiment;

FIG. 5 is a flowchart showing the printing and payment routine executed in the embodiment;

FIG. 6 shows a print job selection window Q displayed on a touch panel TP1 in the embodiment;

FIG. 7 shows a payment request window R displayed on the touch panel TP1 in the embodiment; and

FIG. 8 shows a payment statement table in the embodiment.

### DESCRIPTION OF THE PREFERRED EMBODIMENTS

One mode of carrying out the invention is described below as a preferred embodiment in the following sequence:

A. Embodiment
A1. System Configuration
A2. Functions of Respective Constituents
A3. Printing and Payment Process
A4. Effects of Embodiment

B. Modifications

### A. EMBODIMENT

A1. System Configuration

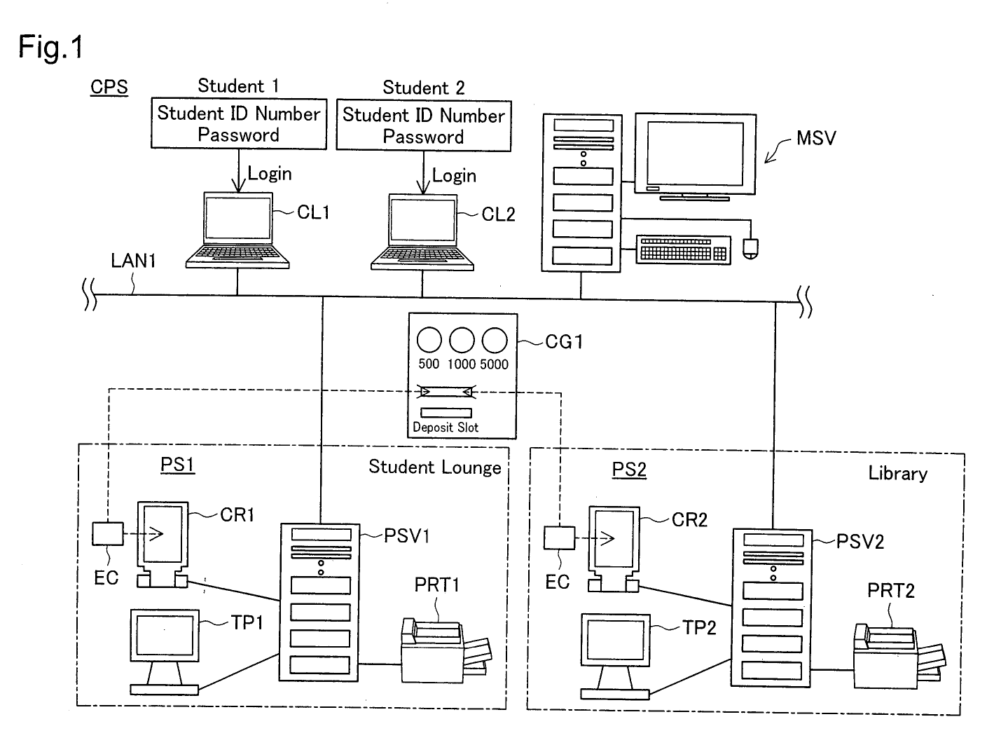

FIG. 1 schematically illustrates the configuration of a campus print system CPS in one embodiment of the invention. The campus print system CPS of the embodiment is established in the campus of a university M as a printing and payment system that is used by students of the university M (hereafter simply referred to as the students) for printing and payment. The campus print system CPS includes a management server MSV, multiple personal computers (PC) for students (hereafter referred to as clients CL) installed in the campus of the university M, multiple printing systems PS installed in the campus of the university M, and multiple chargers CG. The management server MSV, the multiple clients CL, and respective printer servers PSV of the multiple printing systems PS are interconnected via a local area network LAN1. The illustration of FIG. 1 includes only two clients CL1 and CL2 among the multiple clients CL, as well as only a printing system PS1 installed in a student lounge and a printing system PS2 installed in a library among the multiple printing systems PS. Other printing systems PS may be installed in other student-gathering spaces and facilities but are omitted from the illustration and description of this embodiment. The illustration of FIG. 1 also includes only one charger CG1 among the multiple chargers CG.

The TCP/IP protocol is adopted for communication between the devices connecting with the network (for example, between the respective printer servers PSV and the respective clients CL and between the respective printer servers PSV and the management server SV). A fixed IP address is allocated in advance to each device. Communication data sent from a sender device include both an IP address of the sender device (sender IP address) and an IP address of a receiver device (receiver IP address). The communication data is sent to the device identified by the receiver IP address. This is the typical communication flow between any two devices.

A2. Functions of Respective Constituents

Each of the printing systems PS characteristic of the invention has an identical structure and includes the printer server PSV, a card reader CR, a touch panel TP, and a printer PRT. The card reader CR, the touch panel TP, and the printer PRT are respectively linked to the printer server PSV.

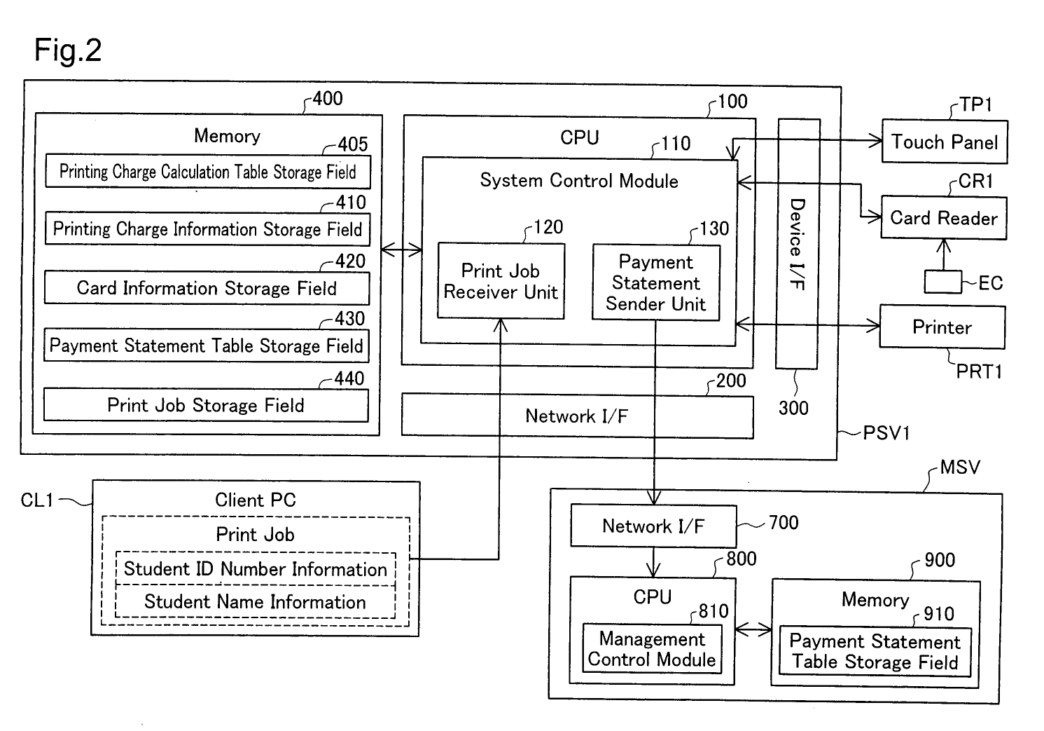

FIG. 2 shows the structure of the printing system PS1 and the management server MSV included in the system of this embodiment. Since the respective printing systems PS have the identical structure as mentioned above, the description regards the functions of the printing system PS1.

A printer server PSV1 includes a CPU 100, a memory 400, a network I/F 200, and a device I/F 300 as shown in FIG. 2.

The device I/F 300 functions to transmit various data to and from a touch panel TP1, a card reader CR1, and a printer PRT1.

The network I/F 200 is a communication interface for network communication and establishes communication with the respective clients CL and the management server MSV via the local area network LAN1.

The CPU 100 reads a preset application program from a certain memory (not shown) and executes the application program to function as a system control module 110 as shown in FIG. 2.

The system control module 110 controls the touch panel TP1, the card reader CR1, and the printer PRT1 for a printing and payment process discussed later. The detailed control procedures of the system control module 110 in the printing and payment process will be described later. The system control module 110 also includes and controls a print job receiver unit 120 and a payment statement sender unit 130.

The print job receiver unit 120 receives print jobs sent from each client CL. The payment statement sender unit 130 sends a payment statement table representing a payment statement for a printing charge (described later) to the management server MSV.

The memory 400 includes a printing charge calculation table storage field 405, a printing charge information storage field 410, a card information storage field 420, a payment statement table storage field 430, and a print job storage field 440.

The printing charge calculation table storage field 405 stores a printing charge calculation table, which specifies a printing charge in relation to each combination of the number of print pages, the paper size, and the information representing color or monochromatic printing (hereafter referred to as color/monochromatic information).

The printing charge information storage field 410 stores printing charge information, which represents a printing charge for a printing result. The card information storage field 420 stores student ID number information, student name information and electronic money information of available electronic money read from a contactless electronic money card EC. The payment statement table storage field 430 stores the payment statement table described later. The print job storage field 440 stores print jobs sent from each client CL.

The printer PRT1 prints each print job sent from the printer server PSV1. On normal completion of the print job, the printer PRT1 sends printing result information on the print job, which includes the total number of print pages, the paper size, and the color/monochromatic information, to the printer server PSV1.

The touch panel TP1 displays a print job list with the student ID number information and the student name information of a student who operates the printing system PS1 for printing, as well as a payment request for a printing charge to the student. The student touches the screen of the touch panel TP1 to select a desired print job in the displayed print job list and give a print instruction. The details of these functions will be described later.

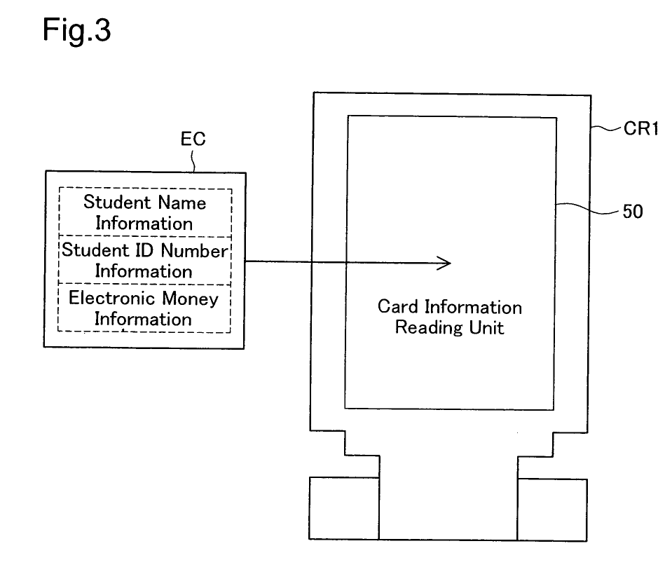

FIG. 3 shows the functions of the contactless electronic money card EC and the card reader CR1 in this embodiment.

The contactless electronic money card EC of this embodiment is distributed to each student from the university M. The contactless electronic money card EC includes an electronic circuit and a memory (not shown). The memory stores student ID number information and student name information of a student as the card owner and electronic money information. The student ID number information and the student name information are registered in advance. The electronic money information stored in the memory includes addition of available electronic money corresponding to a certain amount of money received in a selected charger CG and subtraction of available electronic money by payment when the user places the contactless electronic money card EC close to the card reader CR1 in the printing and payment process.

The card reader CR1 has a card information reading unit 50 to read information from the contactless electronic money card EC as shown in FIG. 3. When the student places the contactless electronic money card EC close to the card information reading unit 50, the card information reading unit 50 reads the student ID number information, the student name information, and the electronic money information stored in the contactless electronic money card EC. The details of the reading operation will be discussed later.

The charger CG receives a certain amount of money and supplies electronic money equivalent to the received money to the contactless electronic money card EC. For example, the charger CG receives money of 1000 yen from a student and supplies electronic money of 1000 yen to the contactless electronic money card EC.

As shown in FIG. 2, the management server MSV includes a CPU 800, a memory 900, and a network I/F 700.

The network I/F 700 is a communication interface for network communication and establishes communication with the respective clients CL and the respective printer servers PSV via the local area network LAN1.

The CPU 800 reads a preset application program from a certain memory (not shown) and executes the application program to function as a management control module 810 as shown in FIG. 2.

The management control module 810 receives the payment statement table sent from each printer server PSV and stores the payment statement table into a payment statement table storage field 910 reserved in the memory 900.

Both the printer server PSV and the management server SV have diversity of additional constituents generally included in the computer, although these constituents are omitted from the illustration and description.

A3. Printing and Payment Process

In the campus print system CPS of this embodiment, a student logs into a certain client CL, selects a desired printer server PSV among options of multiple printer servers PSV registered in advance in the client CL, and sends print jobs to the selected printer server PSV. The student then goes to the location of the selected printer server PSV as the receiver of the print jobs and places a contactless electronic money card EC close to the card reader CR connecting with the selected printer server PSV for authentication. The authenticated student operates the touch panel TP connecting with the selected printer server PSV to select a desired print job among the print jobs sent by the student and give a print instruction of the selected print job. The student obtains resulting prints corresponding to the selected print job from the printer PRT connecting with the printer server PSV. The student again places the contactless electronic money card EC close to the card reader CR to pay for a printing charge of the obtained prints. The operations and the functions of the respective devices in the printing and payment process are described below in detail.

Multiple printer servers PSV connecting with the local area network LAN1 are registered as possible options in advance in each client CL. When a student enters the student ID number as the login name and a predetermined password in a certain client CL, the client CL allows the student to log in and stores the entered student ID number as the student ID number information. After the permission of login, the client CL sends an inquiry to the management server MSV, acquires the student name information corresponding to the student ID number information from the management server MSV, and stores the acquired student name information. When the student selects a desired printer server PSV as the receiver of print jobs and gives a transmission instruction of the print jobs, the client CL attaches the student ID number information and the student name information corresponding to the login student to a header of each of the print jobs and sends the print jobs with the attached information to the selected printer server PSV.

The printer server PSV receives the print jobs sent from the student, stores the received print jobs into the print job storage field 440, and executes the print and payment process described below.

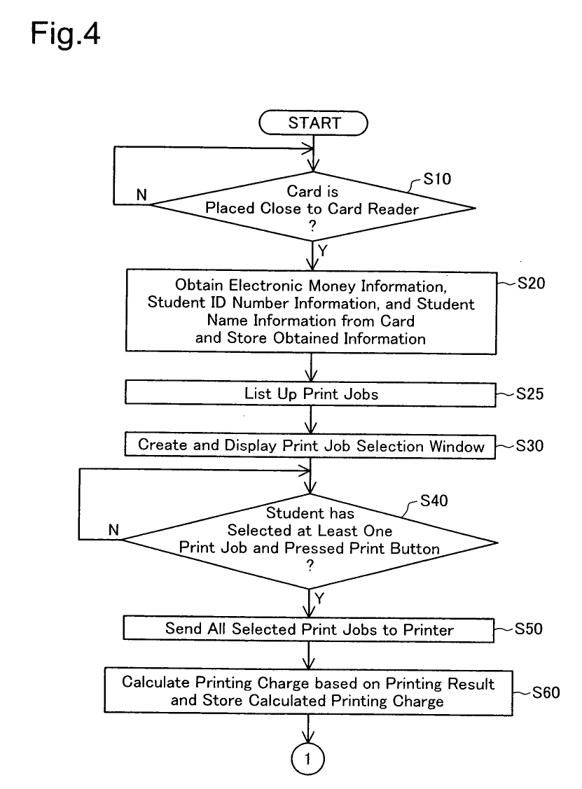

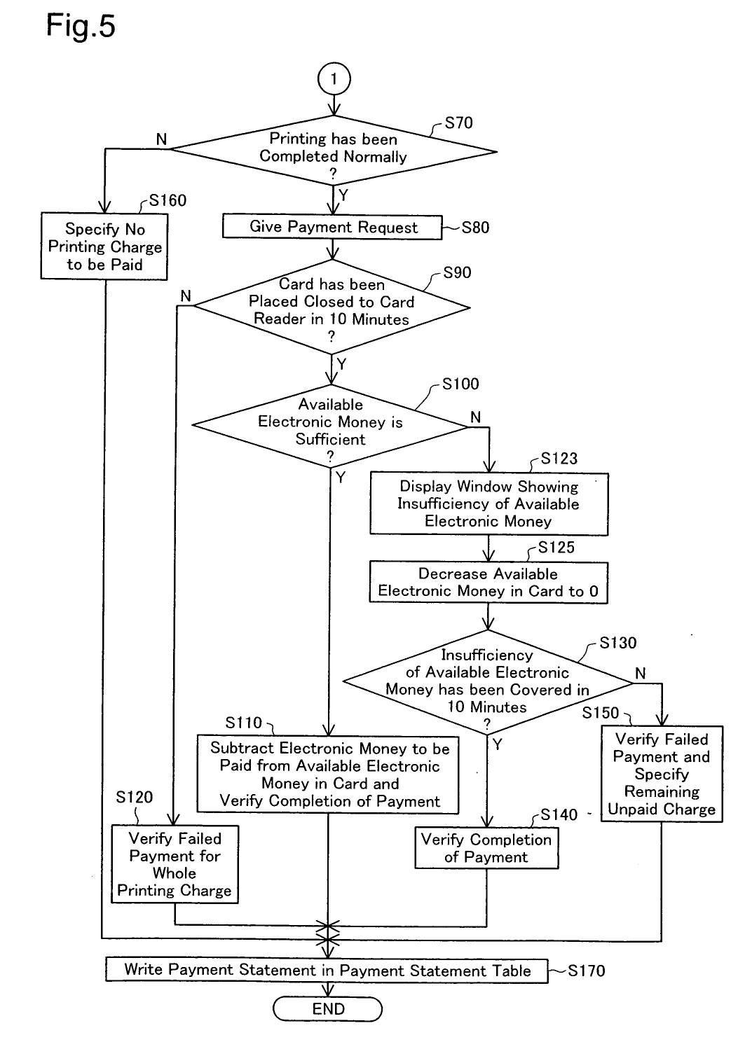

FIGS. 4 and 5 are flowcharts showing a print and payment routine executed in this embodiment.

In the flowchart of FIG. 4, the system control module 110 of the printer server PSV1 first determines whether a student places a contactless electronic money card EC close to the card reader CR1 (step S10). The system control module 110 waits until a student places a contactless electronic money card EC close to the card reader CR1 (step S10: No).

When a student (student X in the description hereafter) places a contactless electronic money card EC close to the card reader CR1 (step S10: Yes), the system control module 110 obtains the student ID number information, the student name information, and the electronic money information of the student X stored in the contactless electronic money card EC via the card reader CR1 and stores the obtained information into the card information storage field 420 (step S20). When the contactless electronic money card EC is placed close to the card information reading unit 50 (see FIG. 3) of the card reader CR1, the card information reading unit 50 transmits radio wave of a specified frequency. In response to reception of the radio wave as the driving force, the electronic circuit of the contactless electronic money card EC sends the student ID number information, the student name information, and the electronic money information stored in the memory to the card reader CR1. The card information reading unit 50 receives the student ID number information, the student name information, and the electronic money information sent from the contactless electronic money card EC and sends the received student ID number information, student name information, and electronic money information to the printer server PSV1. According to this procedure, the system control module 110 obtains the information from the contactless electronic money card EC via the card reader CR1 and stores the obtained information. A typical example of the contactless electronic money card EC is FeliCa (registered trademark by Sony Corporation).

The system control module 110 retrieves the student ID number information attached to the print jobs stored in the print job storage field 440 to find the student ID number information identical with the student ID number information of the student X stored in the card information storage field 420, and lists up the print jobs with attachment of the identical student ID number information (step S25). The system control module 110 may otherwise retrieve the student name information attached to the print jobs stored in the print job storage field 440 to find the student name information identical with the student name information of the student X stored in the card information storage field 420 and list up the print jobs with attachment of the identical student name information.

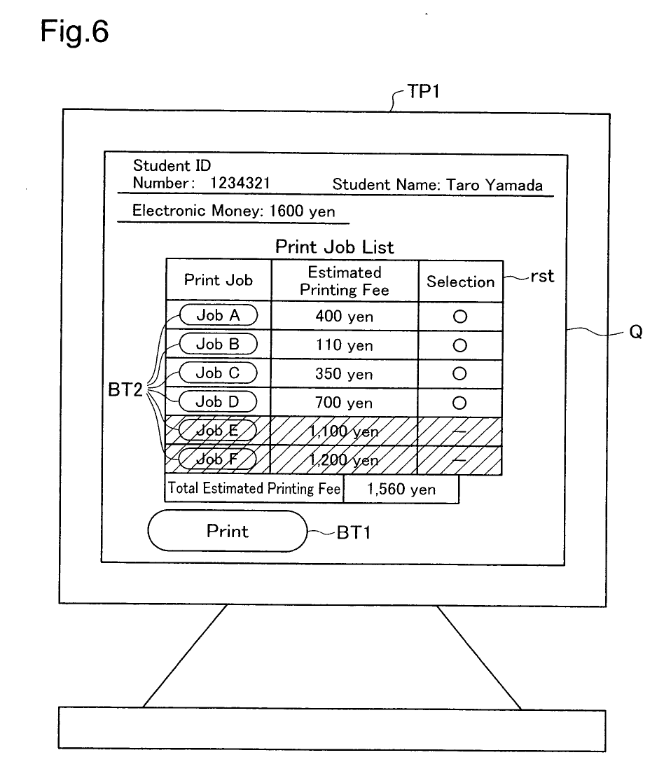

The system control module 110 prepares a print job list rst based on the listed-up print jobs. The print job list rst has an estimated printing fee box corresponding to each print job and a selection box to show selection or non-selection of the print job. The system control module 110 estimates a printing fee of each listed-up print job from the expected total number of print pages for the print job and the paper size and the color/monochromatic information specified by the student at the time of transmission of the print job, and enters the estimated printing fee in the estimated printing fee box of the print job in the print job list rst. The system control module 110 creates a print job selection window Q including the prepared print job list rst and the student ID number information, the student name information, and the electronic money information of the student X stored in the card information storage field 420 and displays the print job selection window Q on the touch panel TP1 (step S30) as shown in FIG. 6.

FIG. 6 shows the print job selection window Q displayed on the touch panel TP1 in the embodiment. The print job selection window Q of FIG. 6 shows the student ID number information, the student name information, and the electronic money information on the top, the print job list rst on the center, and a Print button BT1 on the bottom. The print job selection window Q also has a total estimated printing fee box between the print job list rst and the Print button BT1. Respective print job names included in a print job column of the print job list rst are formed as buttons (Print Job buttons BT2). The symbol ‘o’ in each of the selection boxes in the print job list rst represents selection of a corresponding print job as the print job to be printed. The symbol ‘-’ in the selection box represents non-selection of the corresponding print job as the print job to be printed. In response to each click of a Print Job button BT2 by the student X, the symbol ‘o’ in the corresponding selection box is changed to the symbol ‘-’, whereas the symbol ‘-’ in the corresponding selection box is changed to the symbol ‘o’. The print job list rst includes an available option display area and a grayed-out option display area. The print jobs in the available option display area are selectable by the student X, whereas the print jobs in the grayed-out option display area are unselectable by the student X. In the default, all the print jobs in the available option display area are selected (the symbol ‘o’ in the corresponding selection boxes). The sum of the estimated printing fees for the print jobs in the available option display area is set not to exceed electronic money corresponding to the displayed electronic money information (hereafter referred to as displayed electronic money). The sum of the estimated printing fees (hereafter referred to as the total estimated printing fee) for the print jobs in the available option display area (that is, the print jobs selected by the student X) is entered in the total estimated printing fee box.

When the student X cancels selection of a certain print job in the available option display area, the total estimated printing fee decreases by the estimated printing fee for the cancelled-out print job. When the sum of the decreasing total estimated printing fee and an estimated printing fee for a specific print job in the grayed-out option display area does not exceed the displayed electronic money, the grayed-out display of the specific print job in the grayed-out option display area is activated to allow selection of the specific print job by the student X. Among print jobs A to D selected as the print jobs to be printed in the available option display area in the illustrated example of FIG. 6, it is assumed that the student X cancels selection of the print jobs A and D. The cancellation decreases the total estimated printing fee to the sum 460 yen of estimated printing fees of the remaining selected print jobs B and C. In this case, the sum of the decreasing total estimated printing fee 460 yen and an estimated printing fee 1100 yen for print job E is equal to 1560 yen and does not exceed the displayed electronic money 1600 yen. The grayed-out display of the print job E is accordingly activated to allow selection of the print job E by the student X.

The system control module 110 determines whether the student X has selected at least one print job and pressed the Print button BT1 (step S40). The system control module 110 waits until a click of the Print button BT1 by the student X (step S40: No).

When the student X has selected at least one print job and pressed the Print button BT1 (step S40: Yes), the system control module 110 sends all the selected print jobs as the print jobs to be printed, that is, the print jobs having the symbol ‘o’ in the corresponding selection boxes (see FIG. 6), to the printer PRT1 for printing (step S50). The printer PRT1 conducts the received print jobs to implement printing. On normal completion of the selected print jobs, the printer PRT1 sends printing result information to the printer server PSV1. In the event of failure of the received print jobs due to, for example, some malfunction or defect, the printer PRT1 sends print error information to the printer server PSV1.

The system control module 110 calculates a printing charge based on the received printing result information or print error information and stores the calculated printing charge into the printing charge information storage field 410 (step S60). In response to reception of the printing result information from the printer PRT1, the system control module 110 verifies normal completion of the selected print jobs, refers to the printing charge calculation table stored in the printing charge calculation table storage field 405 to calculate the printing charge corresponding to the received printing result information, and stores the calculated printing charge as the printing charge information into the printing charge information storage field 410. In response to reception of the print error information from the printer PRT1, the system control module 110 verifies failure of the selected print jobs and stores the printing charge information representing a printing charge of 0 yen into the printing charge information storage field 410.

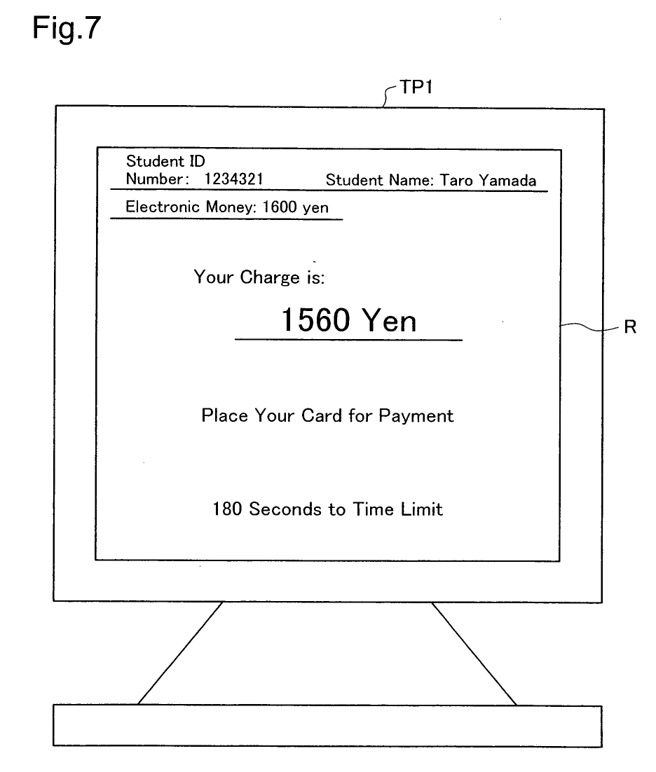

FIG. 7 shows a payment request window R displayed on the touch panel TP1 in the embodiment.

In the flowchart of FIG. 5, in the case of normal completion of the selected print jobs (step S70: Yes), the system control module 110 gives a payment request to the student X, based on the printing charge represented by the printing charge information stored in the printing charge information storage field 410 (step S80). The system control module 110 obtains the printing charge information stored in the printing charge information storage field 410, creates the payment request window R, and displays the created payment request window R on the touch panel TP1 as shown in FIG. 7 to request the student X to pay for the printing charge represented by the obtained printing charge information. The payment request window R shows the printing charge to be paid on the center, and the student ID number information, the student name information, and the electronic money information on the top in the same manner as the print job selection window Q. The payment request window R also shows a remaining time to a time limit for payment with the contactless electronic money card EC.

After the display of the payment request window R on the touch panel TP1, the system control module 110 determines whether the contactless electronic money card EC of the student X has been placed close to the card reader CR1 in 10 minutes (step S90). The contactless electronic money card EC placed close to the card reader CR1 is to be verified as the contactless electronic money card EC of the student X. The verification procedure obtains the student ID number information from the contactless electronic money card EC placed close to the card reader CR1 and compares the student ID number expressed by the obtained student ID number information with the student ID number expressed by the student ID number information stored in the card information storage field 420. In the case of successful matching, the contactless electronic money card EC placed close to the card reader CR1 is verified as the contactless electronic money card EC of the student X. The time limit of 10 minutes is not essential, and the system control module 110 may determine whether the contactless electronic money card EC of the student X has been placed close to the card reader CR1 in any time period set by the system manager.

When the contactless electronic money card EC of the student X has been placed close to the card reader CR1 in 10 minutes (step S90: Yes) after the display of the payment request window R on the touch panel TP1, the system control module 110 obtains the electronic money information from the contactless electronic money card EC via the card reader CR1. The system control module 110 compares available electronic money represented by the electronic money information with the printing charge represented by the printing charge information stored in the printing charge information storage field 410, that is, with the printing charge to be paid, and determines whether the available electronic money is sufficient for the printing charge to be paid (step S100).

When the available electronic money represented by the electronic money information obtained from the contactless electronic money card EC placed close to the card reader CR1 is sufficient for the printing charge to be paid (step S100; Yes), the system control module 110 subtracts an amount of electronic money corresponding to the printing charge to be paid from the available electronic money represented by the electronic money information stored in the contactless electronic money card EC via the card reader CR1 and verifies completion of payment (step S110).

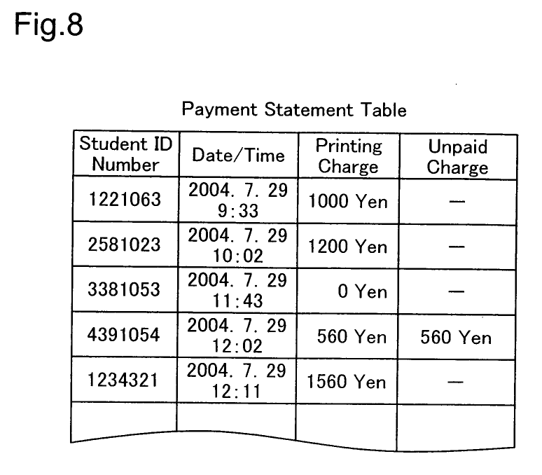

FIG. 8 shows a payment statement table in this embodiment. The payment statement table of FIG. 8 includes columns of student ID number information, date/time information representing the dates and the times of last entries, printing charge information stored at step S60, and unpaid charge information. The symbol ‘-’ in the unpaid charge column of the payment statement table represents completion of payment without any unpaid charge.

On verification of completion of payment (step S110), the system control module 110 enters the student ID number information of the student X stored in the card information storage field 420, the date/time information representing the date and the time of the current entry, the printing charge information stored at step S60, and the symbol ‘-’ representing completion of payment without any unpaid charge as the unpaid charge information in the payment statement table of FIG. 8 (step S170).

When the contactless electronic money card EC of the student X has not been placed close to the card reader CR1 in 10 minutes (step S90: No), the system control module 110 verifies failed payment for the printing charge (unpaid charge) (step S120) and enters the student ID number information of the student X stored in the card information storage field 420, the date/time information representing the date and the time of the current entry, the printing charge information stored at step S60, and the whole printing charge to be paid as the unpaid charge information in the payment statement table of FIG. 8 (step S170).

When the available electronic money represented by the electronic money information obtained from the contactless electronic money card EC placed close to the card reader CR1 is not sufficient for the printing charge to be paid (step S100: No), the system control module 110 displays a window S (not shown) on the touch panel TP1 to inform the student X of an insufficiency of available electronic money and an amount of insufficiency (step S123). The system control module 110 decreases the available electronic money represented by the electronic money information stored in the contactless electronic money card EC to 0 via the card reader CR1 (step S125) and monitors whether the insufficiency of available electronic money has been covered in 10 minutes (step S130).

The student X informed of the insufficiency of available electronic money on the window S transfers money corresponding to the insufficiency of available electronic money to the manager of the printer server PSV1 to cover the insufficiency. The student X may newly supply electronic money to the contactless electronic money card EC from the charger CG1 and place the contactless electronic money card EC again close to the card reader CR1 to cover the insufficiency of available electronic money.

When the student X has covered the insufficiency of available electronic money in 10 minutes (step S130: Yes), the system control module 110 verifies completion of payment (step S140) and enters the student ID number information of the student X stored in the card information storage field 420, the date/time information representing the date and the time of the current entry, the printing charge information stored at step S60, and the symbol ‘-’ representing completion of payment without any unpaid charge as the unpaid charge information in the payment statement table of FIG. 8 (step S170).

When the student X has not covered the insufficiency of available electronic money in 10 minutes (step S130: No), on the other hand, the system control module 110 verifies failed payment for the printing charge and specifies a remaining unpaid charge corresponding to the insufficiency of available electronic money (step S150) and enters the student ID number information of the student X stored in the card information storage field 420, the date/time information representing the date and the time of the current entry, the printing charge information stored at step S60, and the remaining unpaid charge corresponding to the insufficiency of electronic money as the unpaid charge information in the payment statement table of FIG. 8 (step S170).

In the event of failure of the selected print jobs (step S70: No), the system control module 110 specifies no printing charge to be paid (step S160) and enters the student ID number information of the student X stored in the card information storage field 420, the date/time information representing the date and the time of the current entry, the printing charge information stored at step S60, and the symbol ‘-’ representing no unpaid charge as the unpaid charge information in the payment statement table of FIG. 8 (step S170).

On completion of the processing at step S170, the system control module 110 exits from the printing and payment routine.

The system control module 110 keeps the payment request window R (see FIG. 7) displayed on the touch panel TP1 at step S80 until the contactless electronic money card EC of the student X is placed close to the card reader CR1 or until the preset time limit (10 minutes) elapses without placement of the contactless electronic money card EC of the student X close to the card reader CR1 at step S90. Any other students are not allowed to utilize the printing system PS during the display of the payment request window R.

The system control module 110 controls the payment statement sender unit 130 to send the payment statement table stored in the payment statement table storage field 430 to the management server MSV at preset regular intervals. The management control module 810 of the management server MSV receives the payment statement table sent from the printer server PSV1 and stores the received payment statement table into the payment statement table storage field 910.

A4. Effects of Embodiment

In the campus print system CPS of the embodiment described above, on normal completion of printing, the printer server PSV1 keeps the display of the payment request window R on the touch panel TP1 in 10 minutes until the student X who has utilized the printing service places the contactless electronic money card EC close to the card reader CR1. The payment request window R displays the payment request, the student ID number information, and the student name information. In the case where the student X has gone away without required payment, the display notifies people near to the touch panel TP1 (printer server PSV1) of the fact that the student X has not paid for the printing charge. This is naturally awkward for the student X and thus effectively restrains the student X from going away without the required payment.

In the campus print system CPS of the embodiment, the display of the payment request window R is kept on the touch panel TP1 of the printer server PSV1 until the student X places the contactless electronic money card EC close to the card reader CR1. Any other students are not allowed to utilize the printing system PS during the display of the payment request window R. Namely the student X who has gone away without the required payment interferes with utilization of the printing system PS by other students. This is naturally awkward for the student X and thus effectively restrains the student X from going away without the required payment.

In the campus print system CPS of the embodiment, the printer server PSV1 displays the payment request window R including a payment request message and the printing charge to be paid on the touch panel TP1. The student X is thus immediately informed of the printing charge to be paid.

In the campus print system CPS of the embodiment, the print job selection window Q displayed on the touch panel TP1 includes the print job list rst (see FIG. 6). In the print job list rst, the sum of the estimated printing fees for the print jobs in the available option display area is set not to exceed the displayed electronic money. This arrangement prevents the printing charge for the print jobs specified by the student X from exceeding the available electronic money stored in the student X's contactless electronic money card EC and thus effectively reduces the potential for insufficient payment.

In the campus print system CPS of the embodiment, the printer server PSV sends the payment statement table representing the payment statement for printing charges to the management server MSV at preset regular intervals. The manager of the management server MSV is informed of the student ID number of each student who has unpaid, based on the payment statement table stored in the payment statement table storage field 910 of the management server MSV. The manager can thus later request the student identified by the informed student ID number to pay for the unpaid charge. The manager of the management server MSV is also informed of the individual printing charges, based on the payment statement table stored in the payment statement table storage field 910 of the management server MSV. When an external business organization Z manages and maintains the printers PRT, the manager of the management server MSV can pay for the printer leasing based on the payment statement table.

### B. MODIFICATIONS

The embodiment discussed above is to be considered in all aspects as illustrative and not restrictive. There may be many modifications, changes, and alterations without departing from the scope or spirit of the main characteristics of the present invention.

### B1. MODIFIED EXAMPLE 1

The embodiment of the printing and payment system regards the campus print system CPS established in the campus of the university M. The technique of the invention is, however, not restricted to the campus print system CPS. The printing and payment system may be established in any companies and other organizations, as well as in any facilities open to the public to exert the similar functions and effects to those of the above embodiment.

### B2. MODIFIED EXAMPLE 2

The campus print system CPS of the embodiment is constructed as the payment system for printing charges. The technique of the invention is, however, not restricted to the printing and payment system but is applicable to diversity of other charge settlement systems for pay-later services. For example, the charge settlement technique of the invention is applicable to a system including printer servers PSV connected with issuing machines (not shown) and is used to pay for issuing charges of certificates and other issues. In another example, the charge settlement technique of the invention is applicable to a system including printer servers PSV connected with copying machines (not shown) and is used to pay for copying charges.

### B3. MODIFIED EXAMPLE 3

In the system of the embodiment, the system control module 110 displays the payment request window R on the touch panel TP1 to request the student X to pay for the printing charge. Such display is, however, not restrictive but may be replaced or modified in various ways. For example, the printer server PSV may have an audio function unit (not shown). The system control module 110 controls the audio function unit to give a voice message and request the student X to pay for the printing charge. The audio function unit may repeatedly give a voice message, for example, ‘Mr. Taro Yamada, Student ID Number 1234321. Your printing charge is 1560 yen. Please place your contactless electronic money card EC close to the card reader CR for payment’ to request the student X to pay for the printing charge. This arrangement has the similar effects to those of the above embodiment.

### B4. MODIFIED EXAMPLE 4

In the system of the embodiment, the student ID number information and the student name information are used to identify each student. The identification of each student is, however, not restricted to such information. For example, a registered ID may be used for the same purpose. In place of the student ID number information and the student name information, the ID is registered in advance in the contactless electronic money card E and is used as the login name for a login to the client CL. The management server MSV has a management table that relates the ID to each student and allows authentication of each student corresponding to the ID. This arrangement has the similar effects to those of the above embodiment.

### B5. MODIFIED EXAMPLE 5

The system of the embodiment utilizes the contactless electronic money card EC. The contactless electronic money card EC is, however, not restrictive but may be replaced by any other contactless storage medium that stores electronic money information and information for identifying each student (for example, the student ID number information). Some available examples to replace the contactless electronic money card EC include a cell phone with the FeliCa (registered trademark by Sony Corporation) functions and a PDA with the FeliCa functions. These contactless storage media ensure the similar functions and effects to those of the contactless electronic money card EC.

### B6. MODIFIED EXAMPLE 6

In the printing and payment process of the embodiment described above, the system control module 110 keeps the display of the payment request window R (see FIG. 7) until the contactless electronic money card EC of the student X is placed close to the card reader. CR1 or until the preset time limit (10 minutes) elapses without placement of the contactless electronic money card EC of the student X close to the card reader CR1. This arrangement is, however, not restrictive. For example, the system control module 110 may flash or blink the display of the payment request window R on the touch panel TP1. The flashed or blinked display is readily noticeable to other people and thus effectively urges the student X to pay for the printing charge.

### B7. MODIFIED EXAMPLE 7

In the system of the embodiment, the respective constituents of the printer server PSV and the management server MSV actualized by the software configuration may be replaced by the hardware configuration, whereas those actualized by the hardware configuration may be replaced by the software configuration.

Finally the present application claims the priority based on Japanese Patent Application No. 2004-250645 filed on Aug. 30, 2004, which is herein incorporated by reference.

What is claimed is:

1. A charge settlement device having an information reading unit,
when a certain fee is charged to a user and the user places a contactless storage medium, which stores electronic money information and user identification information for identification of the user, close to the information reading unit, the charge settlement device subtracting an amount corresponding to the certain fee from available electronic money represented by the electronic money information for payment of the certain fee,
the charge settlement device comprising:
a notification unit; and
a system control module that controls the information reading unit and the notification unit,
when the user places the contactless storage medium close to the information reading unit, the system control module controlling the information reading unit to obtain at least the user identification information from the contactless storage medium,
the system control module identifying the user based on the obtained user identification information,
in response to detection of the certain fee charged to the identified user, the system control module controlling the notification unit to keep indication of the user identification information and a payment request, which asks the user to place the contactless storage medium close to the information reading unit for payment, until the user actually places the contactless storage medium close to the information reading unit.

2. The charge settlement device in accordance with claim 1, wherein in response to detection of the certain fee charged to the identified user, the system control module controls the notification unit to keep indication of an amount of money to be paid corresponding to the certain fee, together with the user identification information and the payment request to ask the user to place the contactless storage medium close to the information reading unit for payment.

3. The charge settlement device in accordance with claim 1, wherein the system control module controls the notification unit to terminate the indication when the user has not placed the contactless storage medium close to the information reading unit for payment within a predetermined time period.

4. A printing charge settlement device having a printing unit and an information reading unit,
when a printing fee is charged to a user for a print by the printing unit and the user places a contactless storage medium, which stores electronic money information and user identification information for identification of the user, close to the information reading unit, the printing charge settlement device subtracting an amount corresponding to the printing fee from available electronic money represented by the electronic money information for payment of the printing fee,
the printing charge settlement device comprising:
a notification unit; and
a system control module that controls the information reading unit and the notification unit,
when the user places the contactless storage medium close to the information reading unit, the system control module controlling the information reading unit to obtain at least the user identification information from the contactless storage medium,
the system control module identifying the user based on the obtained user identification information,
in response to detection of the printing fee charged to the identified user for the print by the printing unit, the system control module controlling the notification unit to keep indication of the user identification information and a payment request, which asks the user to place the contactless storage medium close to the information reading unit for payment, until the user actually places the contactless storage medium close to the information reading unit.

5. The printing charge settlement device in accordance with claim 4, wherein in response to detection of the printing fee charged to the identified user for the print by the printing unit, the system control module controls the notification unit to keep indication of an amount of money to be paid corresponding to the printing fee, together with the user identification information and the payment request to ask the user to place the contactless storage medium close to the information reading unit for payment.

6. The printing charge settlement device in accordance with claim 4, wherein the system control module controls the notification unit to terminate the indication when the user has not placed the contactless storage medium close to the information reading unit for payment within a predetermined time period.

7. The printing charge settlement device in accordance with claim 4, wherein when the user places the contactless storage medium close to the information reading unit, the system control module controls the information reading unit to obtain the electronic money information and the user identification information from the contactless storage medium,
the system control module identifying the user based on the obtained user identification information,
the system control module allowing a print job specified by the identified user to be printed by the printing unit to an extent where a printing charge for the print job does not exceed the available electronic money represented by the obtained electronic money information, and charging the user with the printing fee for the print.

8. A charge settlement system that comprises the charge settlement device in accordance with claim 1 connected to a management server via a network,
the system control module of the charge settlement device storing a log that specifies whether the user has duly paid for the certain fee in response to the payment request, and
the system control module sending the stored log to the management server at a preset timing.

9. A printing charge settlement system that comprises the printing charge settlement device in accordance with claim 4 connected to a management server via a network,
the system control module of the printing charge settlement device storing a log that specifies whether the user has duly paid for the printing fee in response to the payment request, and
the system control module sending the stored log to the management server at a preset timing.

10. A charge settlement method,
when a certain fee is charged to a user and the user places a contactless storage medium, which stores electronic money information and user identification information for identification of the user, close to an information reading device, the charge settlement method subtracting an amount corresponding to the certain fee from available electronic money represented by the electronic money information for payment of the certain fee,
the charge settlement method comprising the steps of:
(a) when the user places the contactless storage medium close to the information reading device, obtaining at least the user identification information from the contactless storage medium via the information reading device;
(b) identifying the user based on the obtained user identification information;
(c) detecting the certain fee charged to the identified user; and
(d) keeping indication of the user identification information and a payment request, which asks the user to place the contactless storage medium close to the information reading device for payment, until the user actually places the contactless storage medium close to the information reading device.

11. A printing charge settlement method,
when a printing fee is charged to a user for a print by a printing device and the user places a contactless storage medium, which stores electronic money information and user identification information for identification of the user, close to an information reading device, the printing charge settlement method subtracting an amount corresponding to the printing fee from available electronic money represented by the electronic money information for payment of the printing fee,
the printing charge settlement method comprising the steps of
(a) when the user places the contactless storage medium close to the information reading device, obtaining at least the user identification information from the contactless storage medium via the information reading device;
(b) identifying the user based on the obtained user identification information;
(c) detecting the printing fee charged to the identified user for the print by the printing device; and
(d) keeping indication of the user identification information and a payment request, which asks the user to place the contactless storage medium close to the information reading device for payment, until the user actually places the contactless storage medium close to the information reading device.

12. A computer program product,
when a certain fee is charged to a user and the user places a contactless storage medium, which stores electronic money information and user identification information for identification of the user, close to an information reading device, the computer program product being used to subtract an amount corresponding to the certain fee from available electronic money represented by the electronic money information for payment of the certain fee,
the computer program product comprising:
a first program code of, when the user places the contactless storage medium close to the information reading device, obtaining at least the user identification information from the contactless storage medium via the information reading device;
a second program code of identifying the user based on the obtained user identification information;
a third program code of detecting the certain fee charged to the identified user;
a fourth program code of keeping indication of the user identification information and a payment request, which asks the user to place the contactless storage medium close to the information reading device for payment, until the user actually places the contactless storage medium close to the information reading device; and
a computer readable medium that stores the first to fourth program codes.

13. A computer program product,
when a printing fee is charged to a user for a print by a printing device and the user places a contactless storage medium, which stores electronic money information and user identification information for identification of the user, close to an information reading device, the computer program product being used to subtract an amount corresponding to the printing fee from available electronic money represented by the electronic money information for payment of the printing fee,
the computer program product comprising:
a first program code of, when the user places the contactless storage medium close to the information reading device, obtaining at least the user identification information from the contactless storage medium via the information reading device;
a second program code of identifying the user based on the obtained user identification information;
a third program code of detecting the printing fee charged to the identified user for the print by the printing device;
a fourth program code of keeping indication of the user identification information and a payment request, which asks the user to place the contactless storage medium close to the information reading device for payment, until the user actually places the contactless storage medium close to the information reading device; and
a computer readable medium that stores the first to fourth program codes.
